(19) United States
(12) Patent Application Publication
(10) Pub. No.: US 2015/0032956 A1
(43) Pub. Date: Jan. 29, 2015

(54) Method and Apparatus for Enhancing Storage Reliability Using Double Link Redundancy Protection

(71) Applicant: Yiren Ronnie Huang, San Jose, CA (US)

(72) Inventor: Yiren Ronnie Huang, San Jose, CA (US)

(73) Assignee: CNEXLABS, Inc., San Jose, CA (US)

(21) Appl. No.: 14/341,260

(22) Filed: Jul. 25, 2014

Related U.S. Application Data
(60) Provisional application No. 61/859,693, filed on Jul. 29, 2013.

(51) Int. Cl. G06F 3/06

(52) U.S. Cl. CPC G06F 3/0619; G06F 3/0689; G06F 3/0665
USPC 711/114

(57) ABSTRACT

A storage device for improving data integrity using a double link RAID scheme is disclosed. The storage device, in one aspect, includes multiple storage blocks, a group of next pointers, and a group of previous pointers. The storage blocks are organized in a sequential order wherein each block is situated between a previous block and a next block. The storage block is a non-volatile memory capable of storing information persistently. Each of the next pointers is assigned to one block to point to the next block. Each of the previous pointers is assigned to one block to indicate the previous block. In one embodiment, a faulty block can be identified in response to a set of next pointers and previous pointers.

### PRIORITY

This application claims the benefit of priority based upon U.S. Provisional Patent Application Ser. No. 61/859,693, filed on Jul. 29, 2013 in the name of the same inventor(s) and having a title of “Method and Apparatus for Enhancing Storage Reliability using a Double Link Redundancy Storage System,” hereby incorporated into the present application by reference.

### FIELD

The exemplary embodiment(s) of the present invention relates to compute storage systems. More specifically, the exemplary embodiment(s) of the present invention relates to data reliability.

### BACKGROUND

With increasing popularity of electronic devices, such as computers, servers, mobile devices, server farms, mainframe computers, and the like, the demand for instant and reliable data is constantly growing. For example, fast and fault-tolerant storage devices which provide data, video, and audio information, are in high demand for wired as well as wireless communications. To provide data integrity, a conventional computer data storage, for example, uses data redundancy, such as using redundant array of inexpensive disk, also known as redundant array of independent disks (“RAID”), to recover and/or correct corrupted data.

Conventional RAID configurations provide several levels of storage schemes wherein each level offers one or more features, such as error tolerance, storage capacity, and/or storage performance. RAID layout typically includes seven (7) levels of storage configuration, namely from RAID 0 to RAID 6. RAID 0 includes one or more striped disk arrays which typically does not offer fault-tolerance. RAID 1 provides fault-tolerance from disk errors by implementing disk minoring which minors the contents of the disks. RAID 2 employs Hamming error correction codes to address fault-tolerances. RAID 3 uses parity bits with a dedicated parity disk with byte-level striping storage configuration. While RAID 4 provides block-level striping (like Level 0) with a parity disk, RAID 5 provides byte level data striping as well as stripes error correction information. RAID 6 offers block level striping wherein the parity bits are stored across multiple disks.

RAID is typically used to provide redundancy for the stored data in a memory or storage device such as hard disk drive (“HDD”). The conventional RAID configuration dedicates a parity disk that stores the data parity which can be used to recover data if one of the data disks fails or is damaged. A drawback associated with a conventional RAID configuration is that the configuration of a RAID disk is typically assigned to a specific fixed set of data disks.

### SUMMARY

One embodiment of the present invention discloses a non-volatile (“NV”) memory or storage device capable of improving data integrity using a double link RAID scheme. The NV memory device is a flash memory based solid state drive (“SSD”) for data storage. The storage device, in one aspect, includes multiple storage blocks, a set of next pointers, and a set of previous pointers. The storage blocks are organized in a sequential ordered ring wherein each block is situated between a previous block and a next block. The storage block is NV memory capable of storing information persistently. Each of the next pointers is assigned to one block and used to indicate the next block. Each of the previous pointers is also assigned to one block and used to indicate the previous block. A faulty block or corrupted block can be identified in response to the next pointers and previous pointers.

During an operation, upon initiating a next link searcher to the storage blocks which are organized in a sequential ring configuration, the next link connectivity is examined based on the set of next link pointers associated with the storage blocks. When a first disconnected link is identified or discovered b the next link searcher, a previous link searcher is subsequently activated. The previous link connectivity is examined based on a set of previous link pointers associated with the storage block. When a second disconnected link is identified, the storage blocks indicated by the first disconnected link and the second disconnected link are analyzed. If the first disconnected link and the second disconnected link indicate the same block, the faulty block is identified.

Additional features and benefits of the exemplary embodiment(s) of the present invention will become apparent from the detailed description, figures and claims set forth below.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1A is a block diagram illustrating a non-volatile (“NV”) memory device configured to improve data reliability using a double link redundancy (“DLR”) configuration in accordance with one embodiment of the present invention;

FIG. 1B is a block diagram illustrating multiple blocks interconnected by DLR for data recovery in accordance with one embodiment of the present invention;

FIGS. 2A-B show logic diagrams illustrating an exemplary process using DLR to locate a faulty block in accordance with one embodiment of the present invention;

FIG. 3 is a logic flow diagram illustrating two groups of blocks organized in two SORs forming a 2D array in accordance with one embodiment of the present invention;

FIG. 4 is a logic diagram illustrating an array of storage blocks containing multiple columns and rows in accordance with one embodiment of the present invention;

FIG. 5 is a block diagram illustrating an array of storage blocks containing multiple columns and rows in accordance with one embodiment of the present invention;

FIG. 6 is a flow diagram illustrating an operation of DLR to identify a faulty block in accordance with one embodiment of the present invention;

FIG. 7 is a diagram illustrating a computer network capable of providing network traffic routing between various users using a DLR storage device in accordance with one embodiment of the present invention; and

FIG. 8 is a block diagram illustrating a digital processing system capable of implementing a DLR storage device in accordance with one embodiment of the present invention.

### DETAILED DESCRIPTION

Embodiments of the present invention are described herein with context of a method and/or apparatus for enhancing data integrity in non-volatile (“NV”) storage memory using a double link redundancy configuration.

The purpose of the following detailed description is to provide an understanding of one or more embodiments of the present invention. Those of ordinary skills in the art will realize that the following detailed description is illustrative only and is not intended to be in any way limiting. Other embodiments will readily suggest themselves to such skilled persons having the benefit of this disclosure and/or description.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application- and business-related constraints, and that these specific goals will vary from one implementation to another and from one developer to another. Moreover, it will be understood that such a development effort might be complex and time-consuming, but would nevertheless be a routine undertaking of engineering for those of ordinary skills in the art having the benefit of embodiment(s) of this disclosure.

Various embodiments of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method. The same reference indicators will be used throughout the drawings and the following detailed description to refer to the same or like parts.

In accordance with the embodiment(s) of present invention, the components, process steps, and/or data structures described herein may be implemented using various types of operating systems, computing platforms, computer programs, and/or general purpose machines. In addition, those of ordinary skills in the art will recognize that devices of a less general purpose nature, such as hardware devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

The term “system” or “device” is used generically herein to describe any number of components, elements, sub-systems, devices, packet switch elements, packet switches, access switches, routers, networks, computer and/or communication devices or mechanisms, or combinations of components thereof. The term “computer” includes a processor, memory, and buses capable of executing instruction wherein the computer refers to one or a cluster of computers, personal computers, workstations, mainframes, or combinations of computers thereof.

A storage device, which can be a NAND flash memory based SSD, is able to improve data integrity using a double link RAID scheme. The storage device, in one aspect, includes multiple storage blocks, next pointers or links, and previous pointers or links. The storage blocks are organized in a sequential ordered ring (“SOR”) wherein each block within SOR is situated between a previous block and a next block. The storage block is fabricated based on flash memory technology capable of storing information persistently. Each of the next pointers is assigned to one block (or host block) for pointing to the next block. Each of the previous pointers is assigned to one block (or host block) for indicating the previous block. In one embodiment, a faulty block can be identified in response to a set of next pointers and previous pointers.

During an operation, upon initiating a next link searcher to the storage blocks in the SOR, next link connectivity is examined based on the set of next link pointers associated with the storage blocks. When a first disconnected link is identified or discovered by the next link searcher, a previous link searcher is activated. The previous link connectivity is subsequently examined based on a set of previous link pointers associated with the storage block. When a second disconnected link is identified, the storage blocks indicated by the first disconnected link and the second disconnected link are analyzed. If the first disconnected link and the second disconnected link indicate the same block, the faulty block is located.

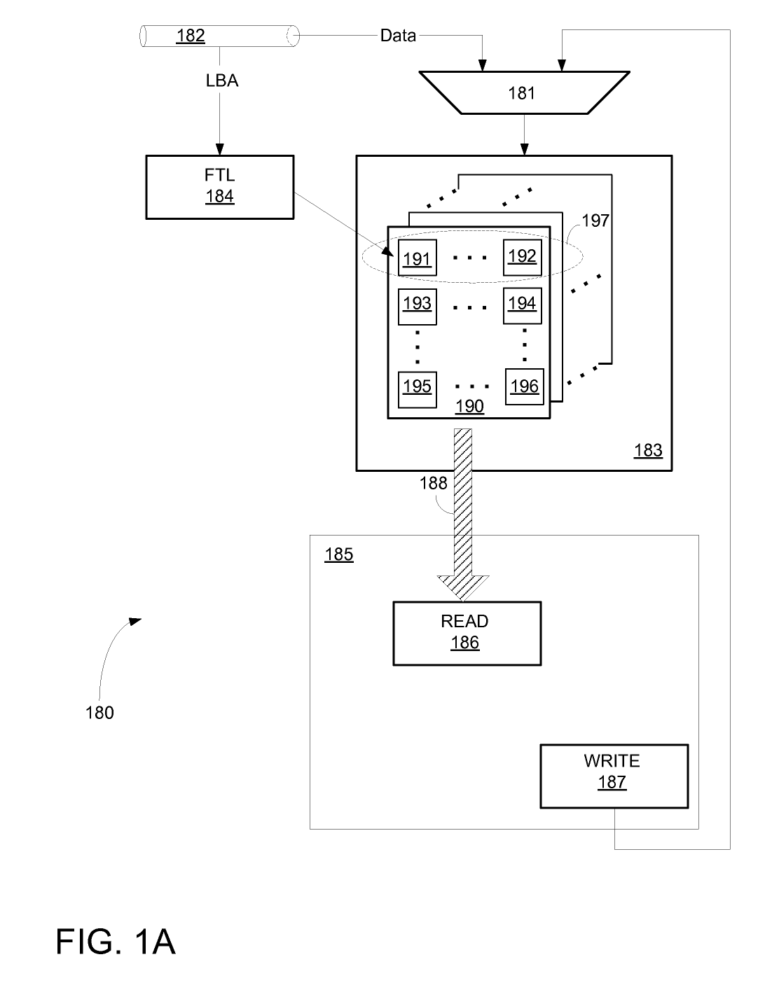

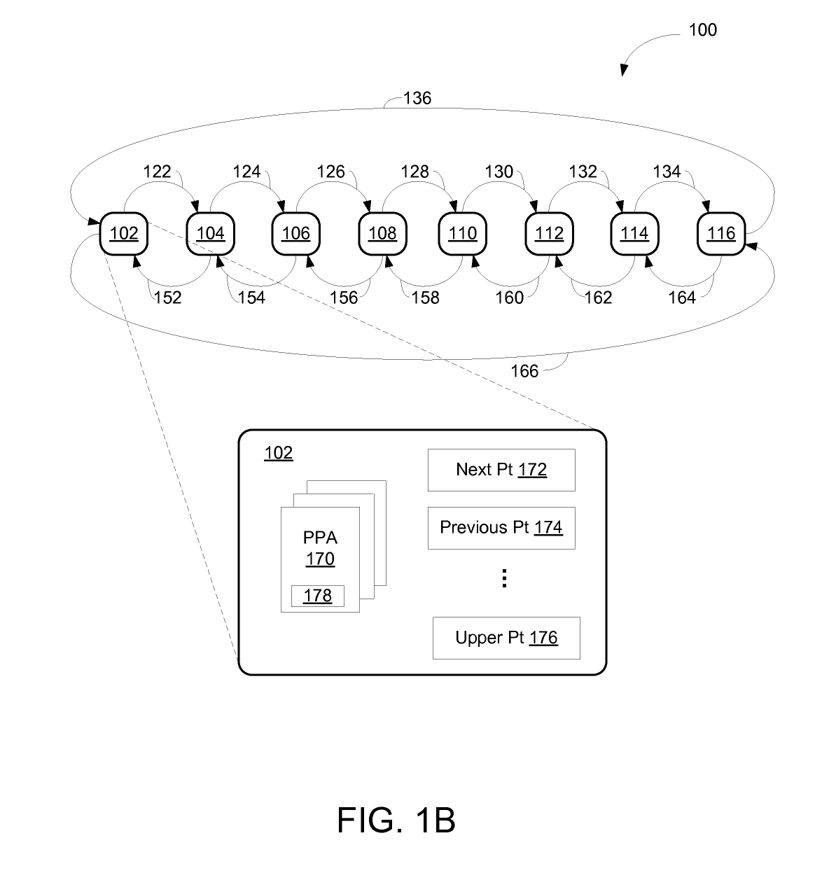

FIG. 1A is a block diagram 180 illustrating an NV memory device configured to improve data reliability using a double link redundancy (“DLR”) in accordance with one embodiment of the present invention. Diagram 180 includes input data 182, memory or storage device 183, output data 188, and storage controller 185. Storage controller 185 further includes read module 186 and write module 187. Diagram 180 also includes a flash translation layer (“FTL”) 184 which can be part of storage controller 185. FTL 184, for example, maps logic block addresses (“LBAs”) to physical addresses. It should be noted that the underlying concept of the exemplary embodiment(s) of the present invention would not change if one or more blocks (or devices) were added to or removed from diagram 180.

A flash memory based SSD, for example, includes multiple arrays of NAND based flash memory cells for storage. The flash memory, which generally has a read latency less than 100 microseconds (“μs”), is organized in a block device wherein a minimum access unit may be set to four (4) kilobyte (“Kbyte”), eight (8) Kbyte, or sixteen (16) Kbyte memory capacity depending on the flash memory technology. Other types of NV memory, such as phase change memory (“PCM”), magnetic RAM (“MRAM”), STT-MRAM, or ReRAM, can also be used. To simplify the forgoing discussion, the flash memory or flash based SSD is herein used as an exemplary NV memory for dual memory access.

Diagram 180 illustrates a logic diagram of SSD using flash memory 183 to persistently retain information without power supply. The SSD includes multiple non-volatile memories or flash memory blocks (“FMB”) 190, FTL 184, and storage controller 185. Each of LBs 190 further includes a set of pages 191-196 wherein a page has a block size of 4096 bytes or 4 Kbyte. In one example, FMB 190 can contain from 128 to 512 pages or sectors or blocks 191-196. A page or block is generally a minimal writable unit. It should be noted that the terms “block”, “page”, “chunk”, and “sector” can be herein used interchangeably.

To improve data integrity, block 191-196 are reconfigured, grouped, and/or organized in one or more sequential ordered rings as indicated by numeral 197 to provide data redundancy. In one example, the data redundancy in SOR blocks can be performed based on RAID using a DLR. Depending on the applications, different RAID configuration may be used with different ratios between data blocks and parity blocks. For example, a four (4) data blocks to one (1) parity block (“4-1”) and/or 7-1 RAID configuration can be used. In one embodiment, DLR is able to selectively link multiple blocks into a SOR for data redundancy.

An advantage of employing DLR is that it is able to selectively organize various blocks to form a SOR for data redundancy.

FIG. 1B is a block diagram 100 illustrating multiple blocks interconnected by DLR for data redundancy in accordance with one embodiment of the present invention. Diagram 100 illustrates a group of storage blocks or blocks 102-116 that are interconnected by next links 122-136 and previous links 152-166 to form a SOR. Storage blocks 102-116, in one embodiment, are part of storage space in an SSD for storing data persistently. For example, blocks 102-116 can be a subgroup of blocks 191-196 shown in FIG. 1A. It should be noted that the underlying concept of the exemplary embodiment(s) of the present invention would not change if one or more blocks (or devices) were added to or removed from diagram 100.

Storage blocks 102-116 are organized in a sequential order connected by various links to form a SOR. Each one of storage blocks is situated between a previous block and a next block. For example, storage block 106 is the next block of storage block 104 pointed by next pointer or link 124. Similarly, storage block 102 is the previous block of storage block 104 pointed by previous pointer or link 152. While majority of storage blocks 102-116 are data blocks for storing digital information, at least one block within the SOR is a RAID block. The RAID block stores recovery data such as parity bits which can be used for data recovery. For example, when one of storage block 102-116 is failed or is corrupted, the RAID block within the SOR is referenced for recovering the data originally stored in the failed or corrupted block.

Each storage block such as block 102, for example, includes next pointer 172, previous pointer 174, upper pointer 176, and one or more physical pages 170 which are addressed by physical page addresses (“PPA”). Each physical page 170 may also include error correction code or error detection mechanism 178. For instance, mechanism 178 includes, but not limited to, error correction code (“ECC”), cyclic redundancy check (“CRC”), parity bits, and the like.

Next pointer 172 is used to indicate or link the host node to the next neighboring block or node. For example, if block 102 is the host node, next pointer 172 should point to storage block 104 as the next neighboring block. Similarly, the previous pointer is used to indicate or link the host block to the previous neighboring block or node. For example, previous pointer 174 indicates storage block 116 as the previous node of block 102. It should be noted that the terms “storage block” and “node” can be used interchangeably. Storage block 102, in one example, includes additional pointers such upper pointer 176 which can be used to indicate an upper level node when a two-dimensional (“2D”) array of nodes is formed.

In one embodiment, a storage device such as SSD includes a controller or storage manager capable of isolating a corrupted or faulty block based on the analysis of links using the pointers. In an alternative embodiment, the memory or storage device includes an additional group of storage blocks, not shown in FIG. 1B, which can be coupled to blocks 102-116 via DLR to form a 2D array of storage blocks. Each column of the 2D array contains at least one RAID block for data redundancy. Alternatively, the 2D array of storage blocks allocates one entire column for RAID blocks.

Diagram 100 illustrates SOR storage blocks 102-116 using double link RAID scheme for improving data reliability. The RAID provides redundancy to the data stored. The RAID scheme such as RAID 4 stores parity bits for the data stored in the various blocks. When data in one block is corrupted, the RAID block is used to recover or reconstruct correct data from corrupted data. The double link pointers system, using previous pointers and next pointers, is able to identify the corrupted block or member in the SOR. It should be noted that blocks within a SOR can also be referred to as members of SOR.

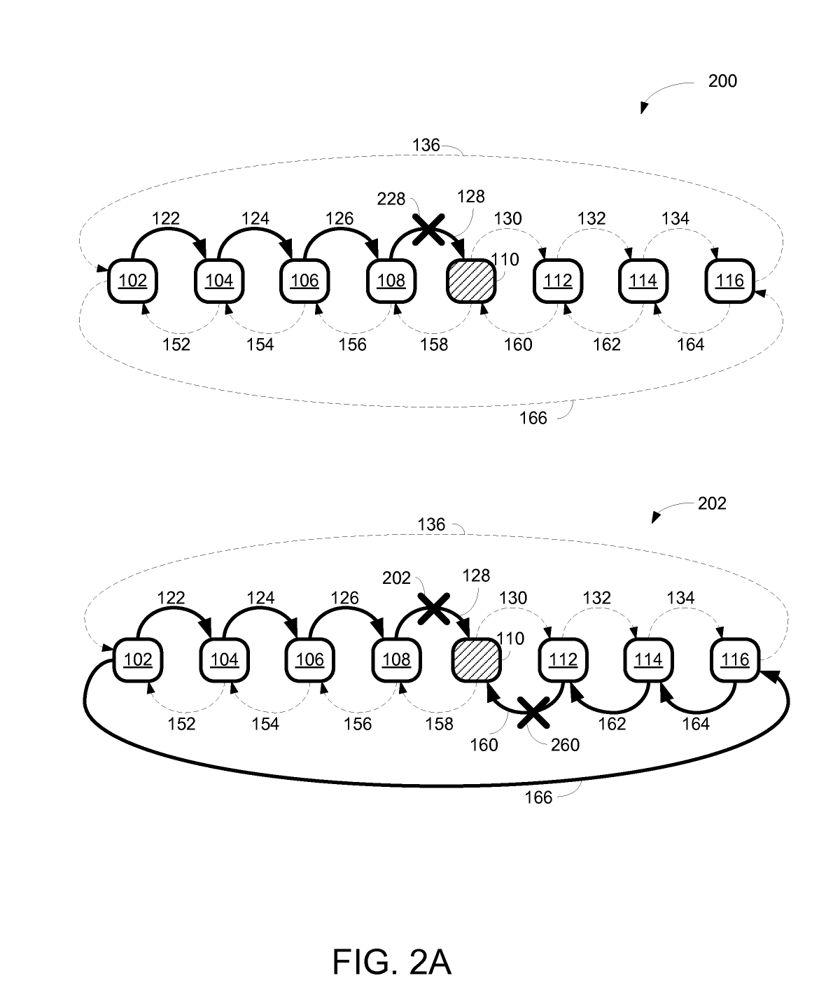

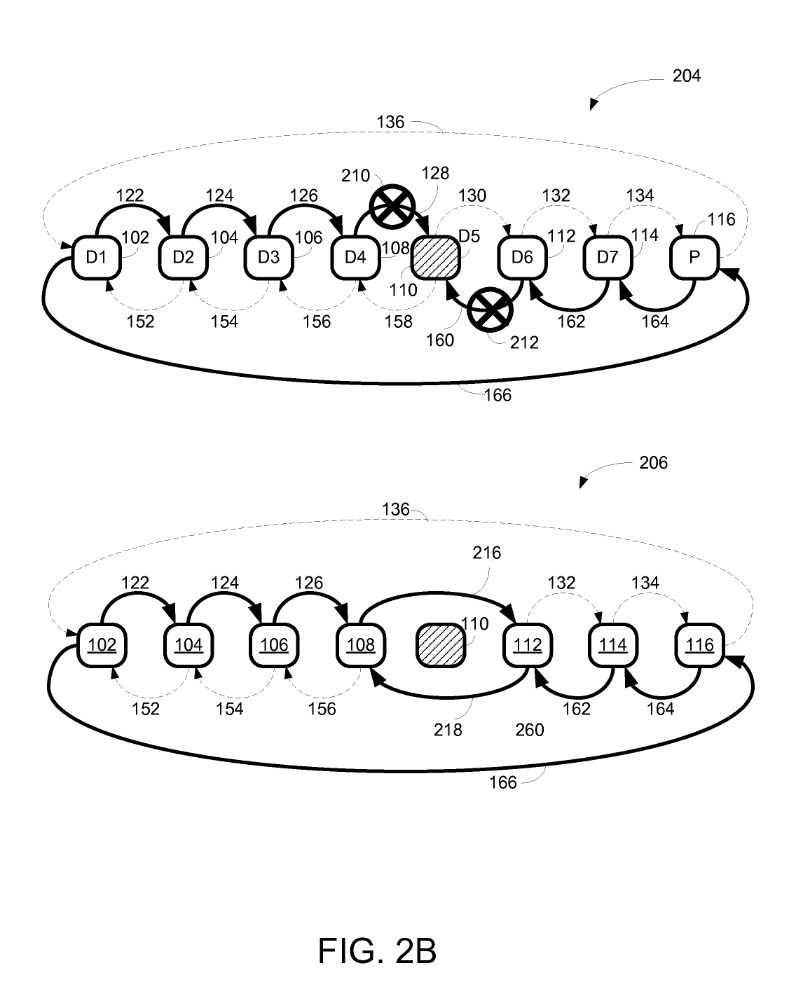

FIG. 2A shows two logic diagrams 200-202 illustrating an exemplary process using DLR to locate a faulty or corrupted block in accordance with one embodiment of the present invention. Diagram 200 illustrates a set of eight blocks or nodes 102-116 configured in a SOR using DLR as shown in FIG. 1B. Upon detecting a potential faulty block within the SOR, a faulty node identifier, which can be resided in the controller, is activated at a predefined node location such as block 102. After initiating the next link searcher, block 102 identifies the next node is block 104 based on link 122. The next link searcher proceeds to identify blocks 106 and 108 in accordance with links 124-126, respectively. When block 108 detects a failure 228 associated with next link 128, the faulty node identifier acknowledges that block 110 may be the faulty node according to the next link searcher. It should be noted that when a node or block is corrupted or failed, the links associated with the corrupted block are likely failed as well.

To verify the finding of the next link searcher, the faulty node identifier initiates a previous link searcher at block 102 as illustrated in diagram 202. Block 102 identifies the previous node is block 116 based on link 166. The previous link searcher proceeds to identify blocks 114 and 112 in accordance with links 164 and 162, respectively. When block 112 detects a failure 260 associated with link 160, the faulty node identifier is informed by the previous link searcher that block 110 may be corrupted based on link failure on link 160. When both next link searcher and previous link searcher point to the same node or block such as block 110, the fault block is identified.

FIG. 2B shows two logic diagrams 204-206 illustrating an exemplary process of handling corrupted block in accordance with one embodiment of the present invention. Diagram 204 illustrates a recovery process after the faulty or corrupted block such as block 110 is identified as illustrated in diagrams 200-202 in FIG. 2A. According to diagram 204, blocks 102-114 are data blocks D1-D7, and block 116 is the parity block P used for data recovery via RAID scheme. The RAID parity, in one example, can be calculated through the formula P=D1̂D2̂D3̂D4̂D5̂D6̂D7, wherêis an exclusive OR operation.

In one embodiment, a RAID reconstruction due to a defective member such as D5 or block 110 can be performed based on RAID like scheme such as RAID 4. For example, when D5 is corrupted, the next and previous pointers of D5 are also corrupted. When the faulty identifier process starts from D1 using the RAID_NEXT pointer such as pointers 122-126, the process can find D2, D3, and D4 successfully. Since D5 is corrupted, the previous link searcher searches backward from D1 using the RAID previous pointers such as pointers 160-166, the node or member P, member D7, and member D6 are identified. To reconstruct D5, the process performs the following formula D5=D1̂D2̂D3̂D4̂D6̂D7̂P for the recovery process.

One embodiment of the present invention includes methods to build previous and next pointers in the double link scheme. For example, one way is to define the absolute value of the previous or next member. To manage a large set of storage elements, the capacity of pointer can be identified as 2^{N}=range capacity or N=LOG₂. Alternatively, a relative addressing scheme may be used for previous and/or next pointers. Depending on the applications, the relative addressing scheme may use fewer bits for the RAID_NEXT or RAID_PREV pointers. For example, to skip three (3) defective members, two (2) bits field is required in which 0 means no skip, 1 means skip 1, 2 means skip 2, and 3 means skip 3 RAID members.

Diagram 206 illustrates an isolation process after a faulty or corrupted block such as block 110 is identified by the process illustrated in diagrams 200-202 in FIG. 2A. When the storage controller discovers that D5 or block 110 cannot be recovered via the RAID scheme, a new next link or pointer 216 is established between block 108 and block 112. Similarly, a new previous link or pointer 218 is established between blocks 112 and block 108. After formation of links 216-218, faulty block 110 is isolated. With double link pointers 216-218, the failed member such as block 110 or D5 in the SOR is skipped.

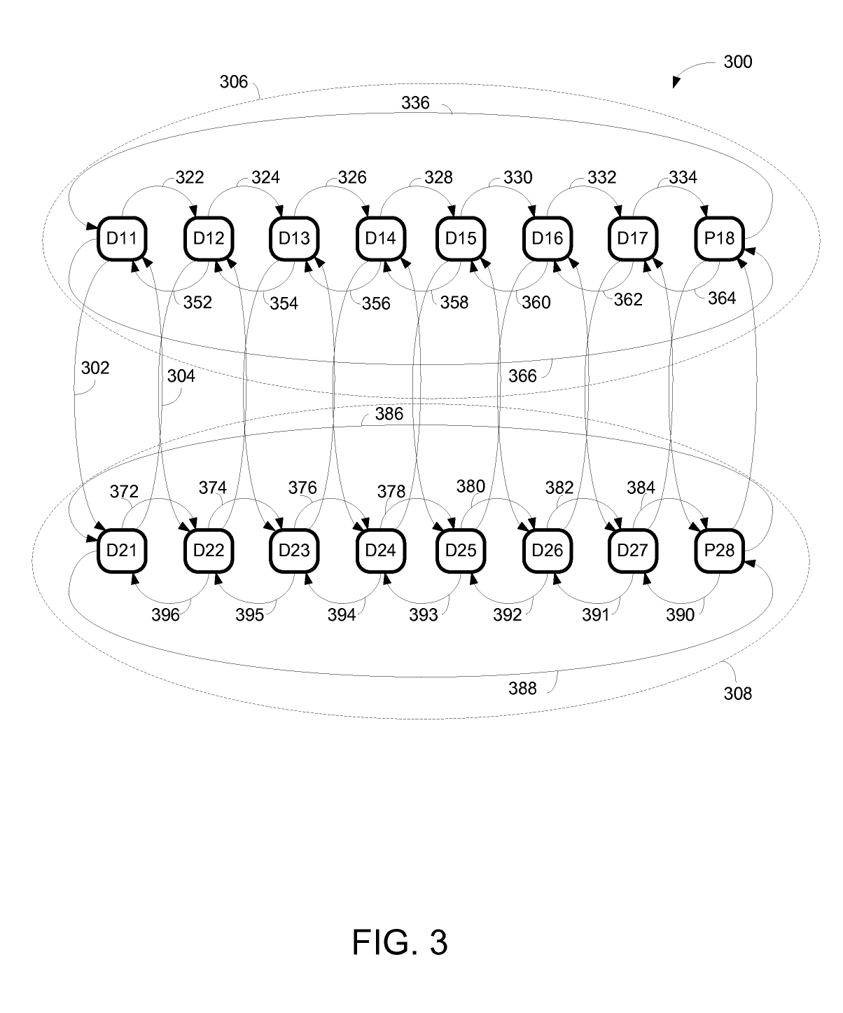

FIG. 3 is a logic diagram 300 illustrating two sets of blocks or members organized in two SORs forming a 2D array in accordance with one embodiment of the present invention. Diagram 300 is similar to diagram 100 shown in FIG. 1B except that diagram 300 includes an additional set of blocks with multiple upper/lower links 302-304. Diagram 300 includes 14 storage data blocks D11-D27, two parity blocks P18 and P28, next links 322-336 and 372-386, previous links 352-366 and 388-390, upper links 304, and lower links 302. It should be noted that the underlying concept of the exemplary embodiment(s) of the present invention would not change if one or more blocks (or links) were added to or removed from diagram 300.

Diagram 300 illustrates a NV memory device containing two SORs 306-308 of blocks wherein SORs 306-308 are interconnected by upper links 304 and lower links 302. To form a 2D array of blocks with 2 SORs 306-308, each block such as block D11 includes a next link 322, previous link 366, down link 302, and upper link 304. An advantage of using a 2D array of blocks is that it is able to identify more than one damaged or corrupted block.

A NV memory able to store data persistently includes a first sequential memory blocks ring as in SOR 306 and a second sequential memory blocks ring configured as SOR 308. The first sequential memory blocks ring provides data integrity based on a RAID scheme which can be RAID 4, RAID 5, and/or RAID 6. Each block, in one example, includes a first next pointer and a second previously pointer. SOR 306 includes seven data blocks D11-D17 and a RAID block P18. P18 is used to facilitate data redundancy.

The second sequential memory blocks ring or SOR 308 is situated adjacent to the first sequential memory blocks ring 306 to form a 2D block array. SOR 308 includes seven data blocks D21-D27 and a RAID block P28. P28 provides redundant information based on the RAID scheme for data recovery in the event that one of the data blocks within SOR 308 fails. Each block includes a second next pointer, a second previously pointer; an upper pointer, and a lower pointer.

To enhance data integrity, the 2D array includes multiple RAID blocks for facilitating data redundancy. In one aspect, the RAID blocks are evenly distributed between columns and rows of the 2D block array. Alternatively, the RAID blocks occupy one entire column of a 2D array. In one embodiment, each column of 2D block array is coupled to an access channels configured to perform read and/or write accesses.

Diagram 300 illustrates a double link RAID system used in multi-dimension RAID applications wherein the double link RAID or DLR scheme is used in the multi-dimension RAID implementation. For a 2D RAID system, the next pointers and previous pointers are used to refer to dimensions relating to the X-axis and Y-axis. It should be noted that the concept of multiple blocks organized in SOR using DLR scheme is also applicable to NV memory chips, NV memory dies, SSDs, or HDDs for data redundancy. One example is to apply the scheme of double link RAID to HDD based RAID array. Another example is to apply the double link RAID to SSD controller where die based RAID scheme is desired. Alternatively, the double link RAID is applicable to SSD controller where chip based RAID scheme is desired.

The double link RAID system is also applicable to a file-based storage system wherein one file can be divided into multiple approximately equal-sized chunks. One dimensional or multi-dimensional RAID scheme with double link RAID can be implemented using the next and previous pointers in the Meta data of every chunk. It should be noted that additional SORs can be added to diagram 300 to generate a larger array or a 3D configuration.

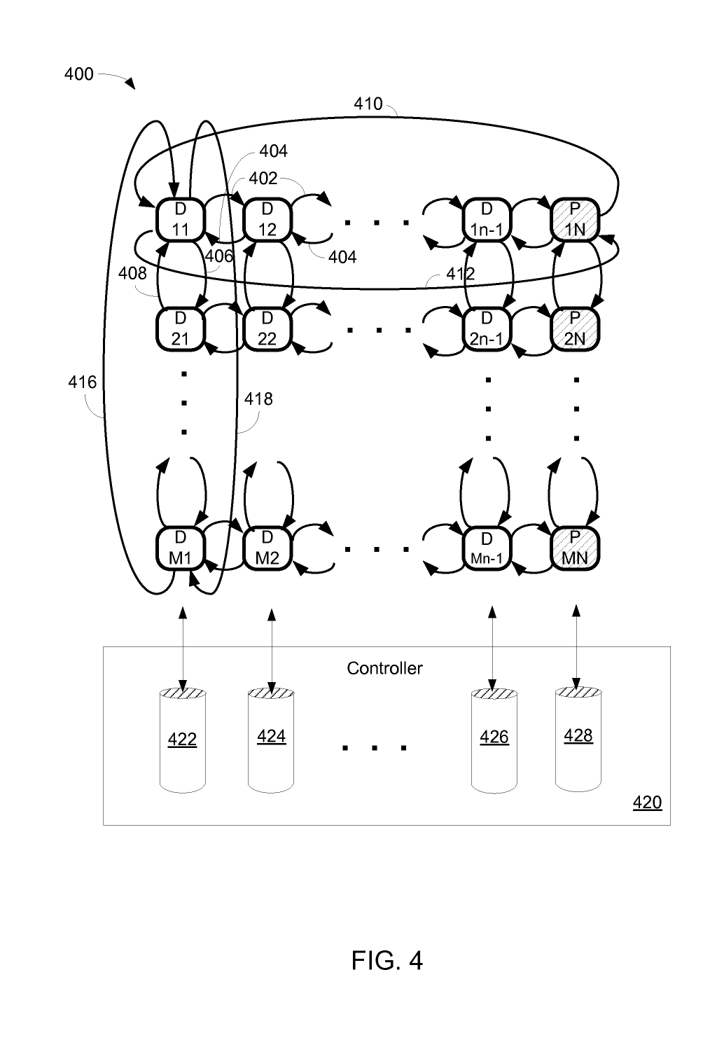

FIG. 4 is a logic diagram 400 illustrating an array of storage blocks containing multiple columns and rows in accordance with one embodiment of the present invention. Diagram 400 includes a controller 420 and M×N (M times N) block array, where M and N are integers. The blocks in the array are interconnected by links 402-418 configured to store data persistently. Controller 420, in one aspect, includes M access channels 422-428. Each column of the M×N block array is coupled to one access channel. In one embodiment, the entire N^{th} column of M×N block array contains RAID blocks P. When a block is corrupted or damaged, a corresponding RAID block is referenced and the data in the corrupted block may be recovered based on the RAID recovery scheme. In an alternative embodiment, the entire M row contains RAID blocks used for facilitating data redundancy and recovery.

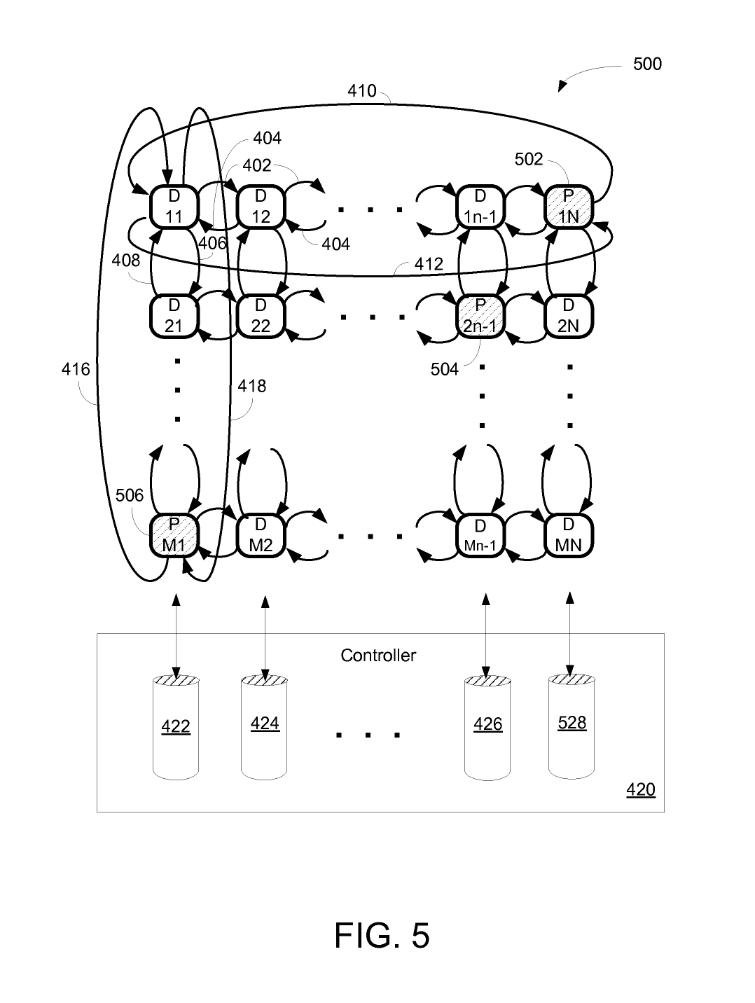

FIG. 5 is a logic diagram 500 illustrating an array of storage blocks containing multiple columns and rows in accordance with one embodiment of the present invention. Diagram 500 is similar to diagram 400 shown in FIG. 4 except that RAID blocks 502-506 in diagram 500 are evenly distributed between columns and rows of the array. For example, RAID block 502 assigned for the redundancy of the first row of array is situated in the last column of the array. RAID block 506 assigned for the redundancy of M row is situated in the first column of the array on the bottom M^{th} row of the array. An advantage of evenly distributing RAID blocks across the array is that it improves efficiency of channel access. For example, access channel 428 shown in FIG. 4 is not used unless at least one block failure is detected. Access channel 528 shown in FIG. 5 is used for data process since majority of blocks in the last column are data blocks.

The exemplary embodiment of the present invention includes various processing steps, which will be described below. The steps of the embodiment may be embodied in machine or computer executable instructions. The instructions can be used to cause a general purpose or special purpose system, which is programmed with the instructions, to perform the steps of the exemplary embodiment of the present invention. Alternatively, the steps of the exemplary embodiment of the present invention may be performed by specific hardware components that contain hard-wired logic for performing the steps, or by any combination of programmed computer components and custom hardware components.

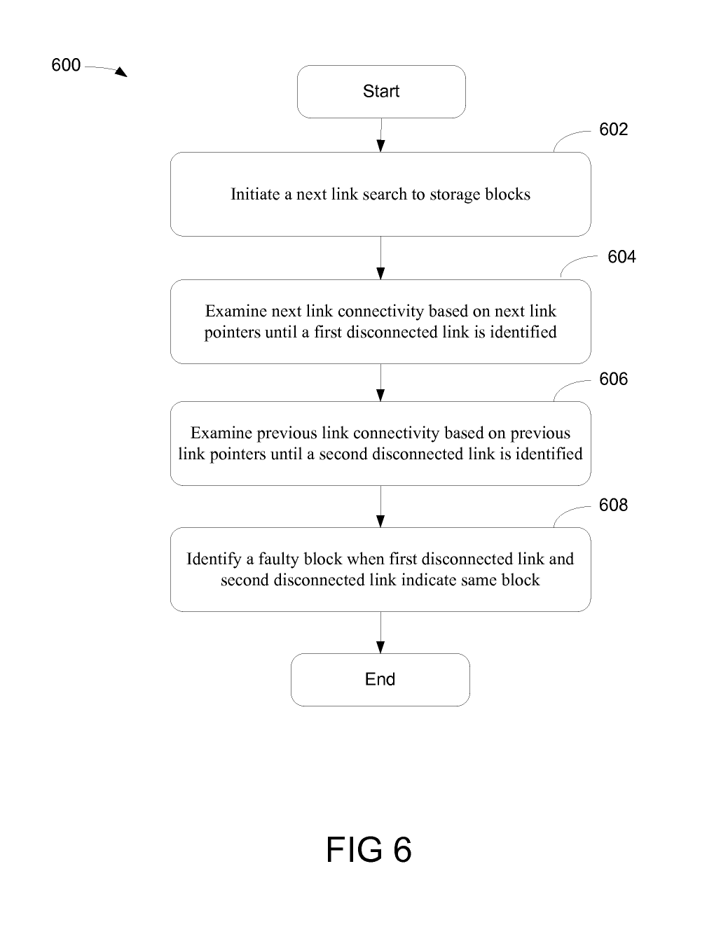

FIG. 6 is a flow diagram 600 illustrating an operation of DLR to identify a faulty block in accordance with one embodiment of the present invention. At block 602, a process capable of improving data integrity using data redundancy initiates a next link searcher to various storage blocks organized in a sequential ring configuration or SOR. In one aspect, the process is implemented by a storage controller used to manage an SSD.

At block 604, the next link connectivity is located and examined based on the next link pointers which are associated with the storage blocks until a first disconnected link is identified or detected. For instance, upon identifying a first next link pointer associated with a first storage block, a second storage block is located as the next block to the first storage block based on the first next link pointer.

At block 606, the previous link connectivity is located and examined based on a set of previous link pointers associated with the storage blocks until a second disconnected link is identified. For example, upon identifying a first previous link pointer associated with the first storage block, a third storage block is located as the previous block to the first storage block in accordance with the first previous link pointer.

At block 608, the process is capable of identifying a faulty block when the first disconnected link and the second disconnected link indicate the same block. In one embodiment, at least two faulty blocks are determined in the storage blocks organized in a SOR when the first disconnected link and the second disconnected link indicate two different blocks. In one aspect, the process is able to adjust the next link pointers and previous link pointers to logically remove the faulty block from the sequential ring configuration or SOR. Alternatively, a recovery process is activated to recover the faulty block in accordance with a predefined RAD scheme.

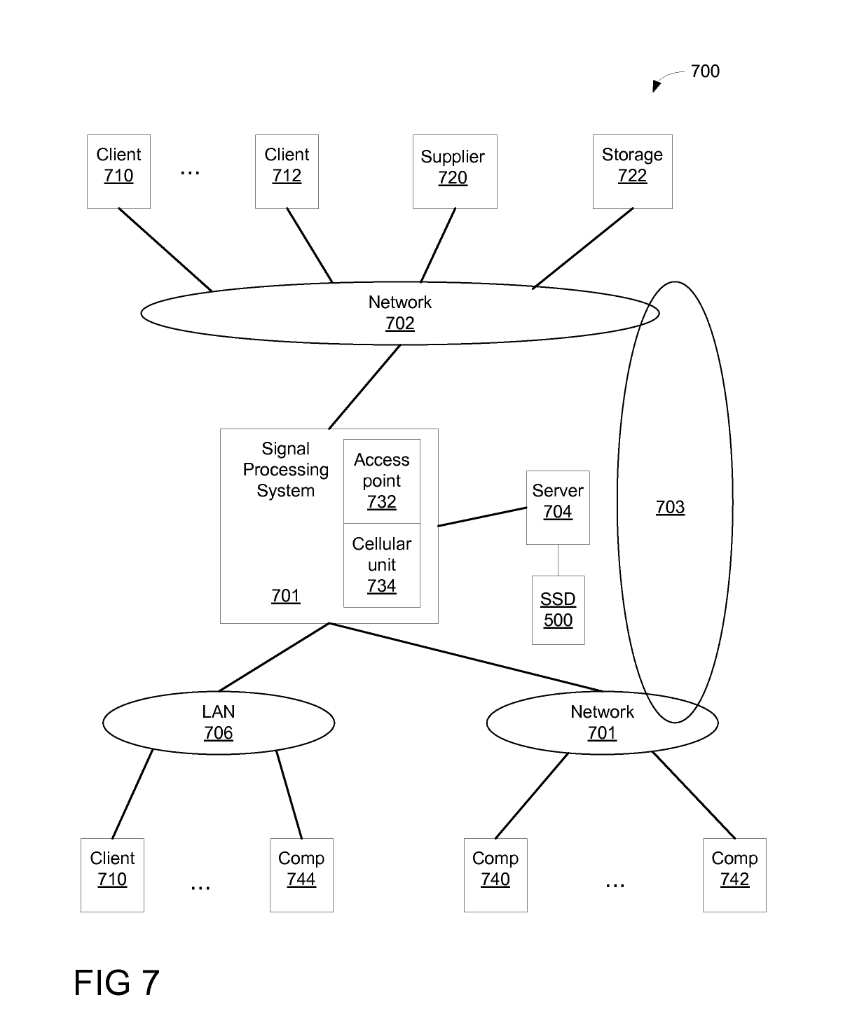

FIG. 7 is a diagram illustrating a computer network 700 capable of providing network traffic routing between various users using a DLR storage device in accordance with one embodiment of the present invention. In this network environment, electronic band 701 can be coupled to a wide-area network 702. Wide-area network 702 includes the Internet, or other proprietary networks including America On-Line™, SBC™, Microsoft Network™, and Prodigy™. Wide-area network 702 may further include network backbones, long-haul telephone lines, Internet service providers, various levels of network routers, and other means for routing data between computers.

Server 704 is coupled to wide-area network 702 and is, in one aspect, used to route data to clients 710-712 through a local-area network (“LAN”) 706. Server 704 is coupled to SSD 500 wherein server 704 can be configured to provide data redundancy using DLR RAID scheme. The LAN connection allows client systems 710-712 to communicate with each other through LAN 706. Using conventional network protocols, USB portable system 730 may communicate through wide-area network 702 to client computer systems 710-712, supplier system 720 and storage device 722. For example, client system 710 is connected directly to wide-area network 702 through direct or dial-up telephone or other network transmission lines. Alternatively, clients 710-712 may be connected through wide-area network 702 using a modem pool.

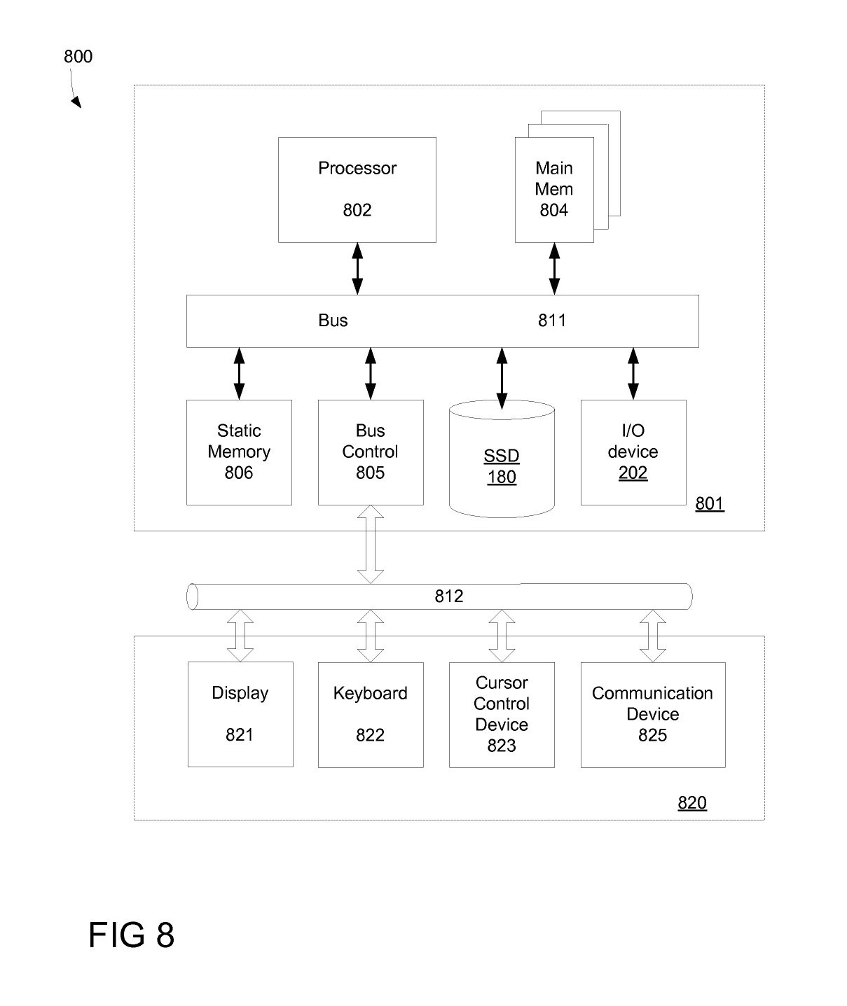

Having briefly described one embodiment of the computer network in which the embodiment(s) of the present invention operates, FIG. 8 illustrates an example of a computer system 800, which can be a server, a router, a switch, a node, a hub, a wireless device, or a computer system.

FIG. 8 is a block diagram illustrating a digital processing system capable of implementing a DLR storage device in accordance with one embodiment of the present invention. Computer system or a signal separation system 800 can include a processing unit 801, an interface bus 811, and an input/output (“IO”) unit 820. Processing unit 801 includes a processor 802, a main memory 804, a system bus 811, a static memory device 806, a bus control unit 805, an SSD as mass storage memory 180, and a signal separation access unit 809. It should be noted that the underlying concept of the exemplary embodiment(s) of the present invention would not change if one or more blocks (circuit or elements) were added to or removed from diagram 800.

Bus 811 is used to transmit information between various components and processor 802 for data processing. Processor 802 may be any of a wide variety of general-purpose processors, embedded processors, or microprocessors such as ARM® embedded processors, Intel® Core™ Duo, Core™ Quad, Xeon®, Pentium microprocessor, Motorola™ 68040,AMD® family processors, or Power PC™ microprocessor.

Main memory 804, which may include multiple levels of cache memories, stores frequently used data and instructions. Main memory 804 may be RAM (random access memory), MRAM (magnetic RAM), or flash memory. Static memory 806 may be a ROM (read-only memory), which is coupled to bus 811, for storing static information and/or instructions. Bus control unit 805 is coupled to buses 811-812 and controls which component, such as main memory 804 or processor 802, can use the bus. Bus control unit 805 manages the communications between bus 811 and bus 812. Mass storage memory or SSD 106, which may be a magnetic disk, an optical disk, hard disk drive, floppy disk, CD-ROM, and/or flash memories are used for storing large amounts of data.

I/O unit 820, in one embodiment, includes a display 821, keyboard 822, cursor control device 823, and communication device 825. Display device 821 may be a liquid crystal device, cathode ray tube (“CRT”), touch-screen display, or other suitable display device. Display 821 projects or displays images of a graphical planning board. Keyboard 822 may be a conventional alphanumeric input device for communicating information between computer system 800 and computer operator(s). Another type of user input device is cursor control device 823, such as a conventional mouse, touch mouse, trackball, or other type of cursor for communicating information between system 800 and user(s).

Communication device 825 is coupled to bus 811 for accessing information from remote computers or servers, such as server 104 or other computers, through wide-area network 102. Communication device 825 may include a modem or a network interface device, or other similar devices that facilitate communication between computer 800 and the network. Computer system 800 may be coupled to a number of servers 104 via a network infrastructure such as the infrastructure illustrated in FIG. 8.

While particular embodiments of the present invention have been shown and described, it will be obvious to those skilled in the art that, based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. A memory device able to store digital information, comprising:
a plurality of storage blocks organized in a sequential order wherein each of the plurality of storage blocks is situated between a previous block and a next block, the plurality of storage block configured to store information persistently;
a plurality of next pointers coupled to the plurality of storage blocks wherein each of the plurality of next pointers is assigned to one of the plurality of storage blocks to point to the next block; and
a plurality of previous pointers coupled to the plurality of storage blocks wherein each of the plurality of previous pointers is assigned to one of the plurality of storage blocks to indicate the previous block.

2. The device of claim 1, wherein the plurality of storage blocks are organized in a redundant array of inexpensive disks (“RAID”) to facilitate data redundancy.

3. The device of claim 2, wherein the plurality of storage blocks, the plurality of next pointers, and the plurality of previous pointers are organized in at least one sequential ring configuration, wherein each ring includes at least one RAID block for data redundancy.

4. The device of claim 1, wherein the plurality of storage blocks is a non-volatile memory device.

5. The device of claim 3, wherein the non-volatile memory device is solid state drive (“SSD”) containing multiple blocks.

6. The device of claim 1, further comprising a controller coupled to the plurality of storage blocks and configured to isolate a faulty block based on active link configurations in accordance with the plurality of next pointers and the plurality of previous pointers.

7. The device of claim 1, further comprising a second plurality of storage blocks which are organized in multiple sequential orders coupled to the plurality of storage blocks to form a two-dimensional array of storage blocks.

8. The device of claim 7, wherein each column of the two-dimensional array of storage blocks contains at least a redundant array of inexpensive disks (“RAID”) block for data redundancy.

9. The device of claim 7, wherein the two-dimensional array of storage blocks contains one column of redundant array of inexpensive disks (“RAID”) blocks for data redundancy.

10. A method of data redundancy, comprising:
initiating a next link searcher to a plurality of storage blocks organized in a sequential ring configuration;
examining next link connectivity based on a plurality of next link pointers associated with the plurality of storage blocks until a first disconnected link is identified;
examining previous link connectivity based on a plurality of previous link pointers associated with the plurality of storage block until a second disconnected link is identified; and
identifying a faulty block when the first disconnected link and the second disconnected link indicate same block.

11. The method of claim 10, further comprising determining at least two faulty blocks in the plurality of storage blocks organized in a sequential ring configuration when the first disconnected link and the second disconnected link indicate two different blocks.

12. The method of claim 10, further comprising adjusting the plurality of next link pointers and the plurality of previous link pointers to logically remove the faulty block from the sequential ring configuration.

13. The method of claim 10, further comprising activating a recovery process to recover the faulty block in accordance with a redundant array of inexpensive disks (“RAID”).

14. The method of claim 10, wherein examining next link connectivity based on a plurality of next link pointers associated with the plurality of storage blocks includes,
identifying a first next link pointer of the plurality of next pointers associated with a first storage block of the plurality of storage blocks; and
locating a second storage block of the plurality of storage blocks based on the first next link pointer.

15. The method of claim 14, wherein examining previous link connectivity based on a plurality of previous link pointers associated with the plurality of storage block includes,
identifying a first previous link pointer of the plurality of previous link pointers associated with a first storage block of the plurality of storage blocks; and
locating a third storage block of the plurality of storage blocks in accordance with the first previous link pointer.

16. A non-volatile memory device able to store data persistently, comprising:
a first sequential memory blocks ring configured to provide data integrity based on a redundant array of inexpensive disks (“RAID”) scheme, wherein each block of the first sequential memory blocks ring includes a first next pointer and a first previously pointer;
a second sequential memory blocks ring situated adjacent to the first sequential memory blocks ring to form a two-dimensional block array, and configured to provide data integrity based on the RAID scheme, wherein each block of the second sequential memory blocks ring includes a second next pointer, a second previously pointer; an upper pointer, and a lower pointer.

17. The device of claim 16, wherein the first sequential memory blocks ring includes a plurality of non-volatile memory blocks wherein one of the plurality of non-volatile memory blocks is a RAID block for facilitating data redundancy.

18. The device of claim 17, wherein the two-dimensional block array contains a set of RAID blocks for facilitating data redundancy.

19. The device of claim 18, wherein the set of RAID blocks of the two-dimensional block array is distributed evenly between columns and rows of the two-dimensional block array.

20. The device of claim 19, further comprising a plurality of access channels coupled to the columns of the two-dimensional block array for data access.
